(19) United States
(12) Patent Application Publication
(10) Pub. No.: US 2026/0036683 A1
(43) Pub. Date: Feb. 5, 2026

(54) DISTANCE MEASUREMENT DEVICE

(71) Applicant: DENSO CORPORATION, Kariya-city (JP)

(72) Inventors: Kenta AZUMA, Kariya-city (JP); Tomoaki YABU, Kariya-city (JP)

(21) Appl. No.: 19/354,326

(22) Filed: Oct. 9, 2025

Related U.S. Application Data
(63) Continuation of application No. PCT/JP2024/014248, filed on Apr. 8, 2024.

(30) Foreign Application Priority Data
Apr. 13, 2023 (JP) 2023-065559

(51) Int. Cl. G01S 7/4865; G01S 17/10

(52) U.S. Cl. CPC G01S 7/4865; G01S 17/10

(57) ABSTRACT

A distance measurement device includes a light emitter for transmitting pulsed light and a light receiver for detecting reflected light from an object, providing an output signal. The device has at least one of a circuit or a processor with memory storing executable computer program code. The circuit or processor calculates an object distance using the time of flight of the pulsed light. Additionally, a histogram representing received light intensity for each time of flight is generated from the output signal. The device determines whether the object is within a short-distance range based on the timing of a peak in the histogram, and calculates the object distance using both a feature value related to the number of light reflections and the timing of the peak's decline.

### CROSS REFERENCE TO RELATED APPLICATIONS

The present application is a continuation application of International Patent Application No. PCT/JP2024/014248 filed on Apr. 8, 2024, which designated the U.S. and claims the benefit of priority from Japanese Patent Application No. 2023-065559 filed on Apr. 13, 2023. The entire disclosures of all of the above applications are incorporated herein by reference.

### TECHNICAL FIELD

The present disclosure relates to a distance measurement device.

### BACKGROUND

Conventional distance measurement devices use light pulses and measure a distance to an object based on the time of flight (TOF) of the light pulses.

### SUMMARY

According to at least one embodiment, a distance measurement device includes a light emitter that emits pulsed light and a light receiver that receives reflected light of the pulsed light reflected by an object and outputs an output signal based on the reflected light. The device has at least one of (i) a circuit and (ii) a processor with a memory storing computer program code executable by the processor. The at least one of the circuit and the processor causes the distance measurement device to calculate an object distance to the object using a time of flight of the pulsed light. The at least one of the circuit and the processor may generate a histogram representing a received light intensity of the reflected light by the light receiver for each time of flight based on the output signal. The device may determine whether the object is within a predetermined short-distance range based on a rising timing of a peak of the received light intensity in the histogram. The device may acquire a feature value related to a number of reflections representing a number of times the pulsed light has reciprocated between the object and the light receiver by reflection based on the histogram. The object distance may be calculated based on the feature value and a falling timing of the peak when the object is within the short-distance range.

### BRIEF DESCRIPTION OF DRAWINGS

The details of one or more embodiments are set forth in the accompanying drawings and the description below. Other features and advantages will be apparent from the description and drawings, and from the claims.

FIG. 1 is an explanatory diagram illustrating a schematic configuration of a distance measurement device according to a first embodiment.

FIG. 2 is an explanatory diagram schematically illustrating a configuration of a light receiving array.

FIG. 3 is a circuit diagram schematically illustrating a configuration of an SPAD circuit.

FIG. 4 is a block diagram illustrating a schematic configuration of the distance measurement device according to the first embodiment.

FIG. 5 is an explanatory diagram illustrating an example of a histogram.

FIG. 6 is a schematic diagram of the histogram.

FIG. 7 is a schematic diagram illustrating an example of the histogram when an object is in a long-distance range.

FIG. 8 is a flowchart of a distance measurement process.

FIG. 9 is a flowchart of a reflection-count determination process.

FIG. 10 is a diagram illustrating first relational data.

FIG. 11 is a diagram illustrating second relational data.

FIG. 12 is a first schematic diagram illustrating an example of the histogram when the object is within a short-distance range.

FIG. 13 is a second schematic diagram illustrating an example of the histogram when the object is within the short-distance range.

FIG. 14 is a block diagram illustrating a schematic configuration of a distance measurement device according to a second embodiment.

FIG. 15 is a diagram illustrating correction data in the second embodiment.

FIG. 16 is a diagram illustrating correction data in another embodiment.

### DETAILED DESCRIPTION

To begin with, examples of relevant techniques will be described.

A distance measurement device is known which emits pulsed lights from a light emitter, detects reflected lights from an object with a light receiver, and measures an object distance by calculating the time of flight (TOF) of the light from emission to reception.

In distance measurement devices, signals different from a desired signal used for distance measurement of the target object, such as signals caused by multiple reflections or clutter, may occur. Here, “clutter” refers to pulsed light that is reflected by a window of a housing accommodating the light emitter and the light receiver. In addition, “multiple reflections” means that the pulsed light emitted from the light emitter makes multiple round trips between the object and the light receiver due to reflections. Due to the effects of such multiple reflections and clutter, there is a risk that the time of flight cannot be measured accurately, resulting in a decrease in distance measurement accuracy.

According to a first aspect of the present disclosure, a distance measurement device includes a light emitter that emits pulsed light and a light receiver that receives reflected light of the pulsed light reflected by an object and outputs an output signal based on the reflected light. The device has at least one of (i) a circuit and (ii) a processor with a memory storing computer program code executable by the processor. The at least one of the circuit and the processor causes the distance measurement device to calculate an object distance to the object using a time of flight of the pulsed light. The at least one of the circuit and the processor also generates a histogram representing a received light intensity of the reflected light by the light receiver for each time of flight based on the output signal. The device determines whether the object is within a predetermined short-distance range based on a rising timing of a peak of the received light intensity in the histogram. The device acquires a feature value related to a number of reflections representing a number of times the pulsed light has reciprocated between the object and the light receiver by reflection based on the histogram. The object distance is calculated based on the feature value and a falling timing of the peak when the object is within the short-distance range.

According to this configuration, when the object is within the short-distance range, the object distance is calculated based on the feature value related to the number of reflections and the falling timing of the peak. By calculating the object distance based on the falling timing of the peak, a reduction in distance measurement accuracy due to the effects of clutter can be reduced. In addition, by calculating the object distance based on the feature value related to the number of reflections, a reduction in the distance measurement accuracy due to the effects of multiple reflections can be reduced. Therefore, the reduction in the distance measurement accuracy caused by the effects of the multiple reflections and the clutter can be reduced.

### First Embodiment

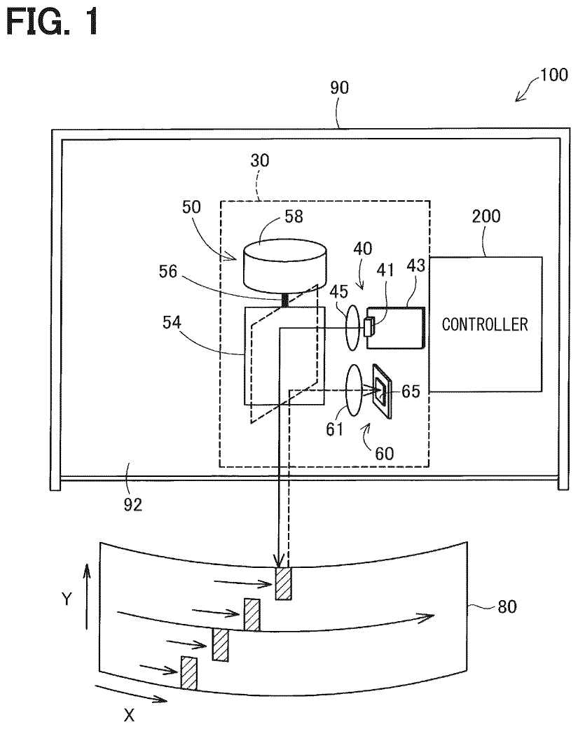

A distance measurement device 100 shown in FIG. 1 includes an optical system 30 that emits pulsed light for distance measurement and receives reflected light from an external object, and a controller 200. The optical system 30 includes a light emitter (light emitting unit) 40 that emits laser light as pulsed light, a scanning unit 50 that scans the laser light within a predetermined visual field range 80 (visual field range), and a light receiver (light receiving unit) 60 that receives incident light including reflected light from the external object and ambient light. The distance measurement device 100 is housed in a casing 90 having a window 92 on its front side. The pulsed light is emitted to an outside of the distance measurement device 100 through the window 92, and the reflected light enters an inside of the distance measurement device 100 through the window 92. The window 92 transmits most of the pulsed light and reflects a portion of the pulsed light.

The distance measurement device 100 is, for example, an in-vehicle LiDAR (Laser Imaging Detection and Ranging) mounted on a vehicle such as an automobile. When the vehicle is traveling on a level road surface, a lateral direction of the visual field range 80 coincides with a horizontal direction X, and a longitudinal direction coincides with a vertical direction Y.

The light emitter 40 includes a laser element 41 that emits laser light as pulsed light, a circuit board 43 incorporating a drive circuit for the laser element 41, and a collimator lens 45 that converts the laser light emitted from the laser element 41 into parallel light. The laser element 41 is a laser diode capable of oscillating so-called short-pulse laser light. In the present embodiment, the laser element 41 forms a rectangular laser emission region by arranging laser diodes along the vertical direction. Intensity of the laser light output by the laser element 41 is configured to be adjustable according to a voltage supplied to the laser element 41.

The scanning unit 50 is configured by a so-called one-dimensional scanner. The scanning unit 50 has a mirror 54, a rotary solenoid 58, and a rotating unit 56. The mirror 54 reflects the laser light that has been collimated into parallel light by the collimator lens 45. The rotary solenoid 58, upon receiving a control signal from the controller 200, repeatedly rotates forward and backward within a predetermined angular range. The rotating unit 56 is driven by the rotary solenoid 58 and repeatedly rotates forward and backward around a rotational axis along in the vertical direction, thereby scanning the mirror 54 in one direction along the horizontal direction. The laser beam emitted from the laser element 41 via the collimator lens 45 is reflected by the mirror 54 and scanned along the horizontal direction by the rotation of the mirror 54. The visual field range 80 shown in FIG. 1 corresponds to an entire scan range of this laser beam. Since the received light intensity can be obtained at each pixel position within the visual field range 80, distribution of the received light intensity within the visual field range 80 constitutes a kind of image. It is also possible to omit the scanning unit 50 and emit pulsed light from the light emitter 40 over the entire visual field range 80, while the light receiver 60 receives the reflected light from the entire visual field range 80. In the present embodiment, the pulsed light is irradiated onto each position within the scanning range, that is, each pixel position within the visual field range 80. Then, the irradiation of this pulsed light and a distance measurement process (described later) based on the reflected light from each pixel position are executed at predetermined time intervals for each pixel position.

When there is an external object (reflective object) such as a person or a vehicle, the laser light emitted from the light emitter 40 is diffusely reflected on its surface, and a portion of this light returns as reflected light to the mirror 54 of the scanning unit 50. This reflected light is reflected by the mirror 54 and, together with ambient light, enters a light-receiving lens 61 of the light receiver 60 as incident light, where it is focused by the light-receiving lens 61 and enters the light receiving array 65. It should be noted that the laser light emitted from the distance measurement device 100 is not limited to being diffusely reflected by external objects, but is also diffusely reflected by objects inside the distance measurement device 100, such as the window 92, and a portion of this reflected light also enters the light receiving array 65.

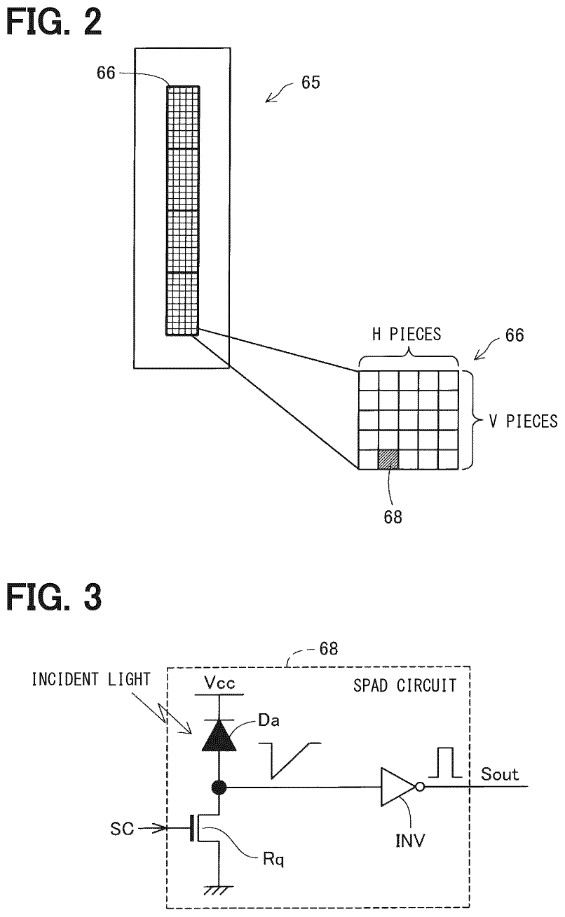

As shown in FIG. 2, the light receiving array 65 has pixels 66 arranged in a two-dimensional array. Each pixel 66 has SPAD (Single Photon Avalanche Diode) circuits 68 arranged in H units in the horizontal direction and V units in the vertical direction. “H” and “V” are each integers equal to or greater than 1. In the present embodiment, H=V=5, and each pixel has five SPAD circuits 68 in both the horizontal and vertical directions. It should be noted that the number of SPAD circuits 68 constituting each pixel 66 is not limited to the above, and, for example, a pixel 66 may be constituted by a single SPAD circuit 68. The light-receiving result of one pixel 66 corresponds to the received light intensity at one pixel position within the visual field range 80.

As shown in FIG. 3, in the SPAD circuit 68, an avalanche diode Da and a quench resistor Rq are connected in series between a power supply Vcc and a ground line. The voltage at their connection point is input to an inverter (INV), which is one type of logic element, thereby converting it into a digital signal with an inverted voltage level. The output signal Sout of the inverter INV is output externally as it is. In the present embodiment, the quench resistor Rq is configured as an FET, and when a selection signal SC becomes active, its on-resistance functions as the quench resistor Rq. When the selection signal SC becomes inactive, the quench resistor Rq enters a high-impedance state, so that even if light is incident on the avalanche diode Da, no quenching current flows, and as a result, the SPAD circuit 68 does not operate. The selection signal SC is output collectively to the 5×5 SPAD circuits 68 within each pixel 66, and is used to specify whether to read out the signals from each pixel 66. In the present embodiment, the avalanche diode Da is operated in Geiger mode (single-photon detection), but it is also possible to use the avalanche diode Da in linear mode (analog signal output without Geiger-mode avalanche) and handle its output as an analog signal. Alternatively, a PIN photodiode may be used in place of the avalanche diode Da.

If no light is incident on the SPAD circuit 68, the avalanche diode Da is maintained in a non-conductive state. Therefore, the input side of the inverter element INV is kept pulled up via the quench resistor Rq, that is, maintained at a high level. Accordingly, the output of the inverter element INV is maintained at a low level. When light is incident on each SPAD circuit 68 from outside, the avalanche diode Da is brought into a conductive state by the incident light (photon). As a result, a large current flows through the quench resistor Rq, causing the input side of the inverter element INV to temporarily go to a low level, and the output of the inverter element INV to invert to a high level. As a result of the large current flowing through the quench resistor Rq, the voltage applied to the avalanche diode Da decreases, cutting off the power supply to the avalanche diode Da, which then returns to the non-conductive state. As a result, the output signal of the inverter element INV is also inverted and returns to the low level. Consequently, when light (a photon) is incident on each SPAD circuit 68, the inverter element INV outputs a pulse signal that is at a high level for a very short period of time. Therefore, by setting the selection signal SC to the high level in synchronization with the timing at which each SPAD circuit 68 receives light, the output signal of the inverter element INV, namely, the output signal Sout from each SPAD circuit 68, becomes a digital signal reflecting the state of the avalanche diode Da. Then, this output signal Sout corresponds to a pulse signal generated by the reception of the incident light, including the reflected light, which is the irradiation light reflected back from external objects or the window 92 within the scanning range, as well as ambient light.

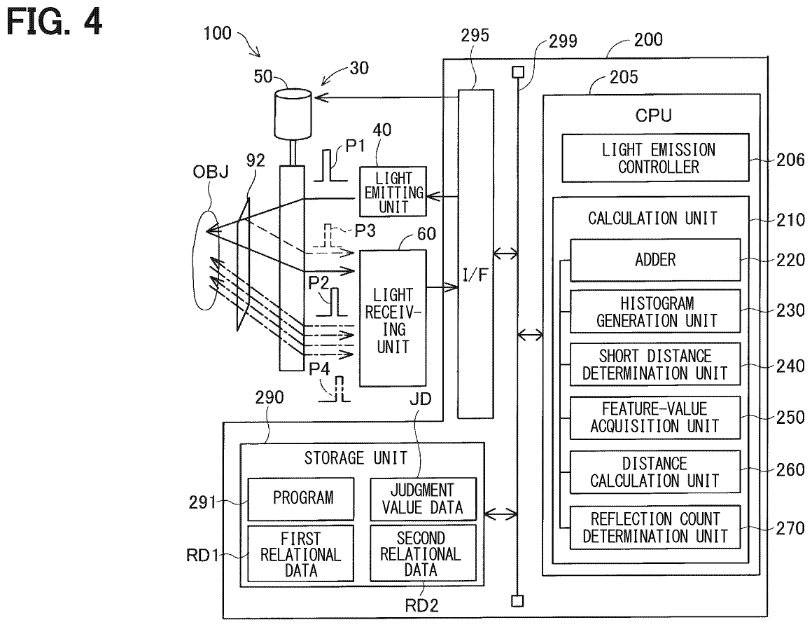

As shown in FIG. 4, the controller 200 includes a central processing device (i.e., CPU) 205, a storage unit 290, and an input/output interface 295. The CPU 205, the storage unit 290, and the input/output interface 295 are each connected via a bus 299 so as to enable bidirectional communication. The light emitter 40, the scanning unit 50, and the light receiver 60 are each connected to the input/output interface 295 via respective control signal lines. The storage unit 290 includes, for example, a read only memory (i.e., ROM), random access memory (i.e., RAM), and EEPROM. The CPU 205 functions as a light emission controller 206 and a calculation unit 210 by executing various programs 291 stored in the storage unit 290. In addition to the program 291, the storage unit 290 stores various types of information such as first relational data RD1, second relational data RD2, and judgment value data JD, which will be described later. The judgment value data JD includes a first judgment value J₁, a second judgment value J₂, a third judgment value J₃, and a fourth judgment value J₄, which will be described later. In other embodiments, some or all of the functions of the controller 200 may be implemented by hardware circuits. Further, for example, the calculation unit 210 may be configured separately from the controller 200.

The light emission controller 206 controls the light emitter 40 and the scanning unit 50. More specifically, the light emission controller 206 performs, for example, transmission of a light emission control signal to the light emitter 40 and transmission of an angle control signal to the scanning unit 50.

The calculation unit 210 calculates an object distance using the time of flight of the pulsed light P1. The object distance refers to a distance from the distance measurement device 100 to the object. As shown in FIG. 4, the pulsed light P1 emitted from the light emitter 40 is reflected by an external object, and reflected light P2 due to the pulsed light P1 is output from the external object. In addition, the pulsed light P1 is also reflected by the inner surface of the window 92, and reflected light P3 due to the pulsed light P1 is output from the window 92. In this specification, reflected light obtained by the pulsed light P1 being reflected on the inner surface of the window 92, such as the reflected light P3, is referred to as “clutter.” In addition, in the distance measurement device 100, the reflected light P4 due to multiple reflections may occur. “Multiple reflections” refers to the phenomenon in which the pulsed light P1 emitted from the light emitter 40 travels back and forth multiple times between the object and the light receiver 60 due to reflection. The reflected light P4 corresponds to the pulsed light P1 that reaches the light receiver 60 after being reflected multiple times by the object. Such reflected light P2, P3, and P4 reaches the light receiver 60. Then, the time from the emission of the pulsed light P1 to the reception of the reflected lights P2, P3, and P4 is specified as the time of flight of the light. The calculation unit 210 uses this time of flight to calculate the object distance.

It should be noted that multiple reflections are more likely to occur when the object is made of a material with high reflectivity (for example, a reflector provided at a rear of a vehicle). In addition, multiple reflections are usually caused when the reflected light from the object is reflected again toward the object by the light receiver 60, and sometimes occur when the reflected light from the object is reflected again toward the object by the window 92. Hereinafter, the number of times the pulsed light travels back and forth between the object and the light receiver 60 due to reflection will also be referred to as the “number of reflections”. The number of reflections can also be said to represent the number of times the pulsed light is reflected by the object before being received by the light receiver 60. A state in which multiple reflections occur corresponds to a state in which the number of reflections is two or more.

As shown in FIG. 4, the calculation unit 210 includes an adder 220, a histogram generation unit 230, a short-distance determination unit 240, a feature-value acquisition unit 250, and a distance-calculation unit 260. Furthermore, the calculation unit 210 in the present embodiment includes a reflection-count determination unit 270.

The adder 220 adds together the outputs of each SPAD circuit 68 included in the pixels 66 that make up the light receiving array 65. When an incident light pulse enters a pixel 66, the SPAD circuit 68 included in the pixel 66 operates. The SPAD circuit 68 is capable of detecting even a single incident photon. However, in the SPAD circuit 68, the detection of the limited light emitted from the external object OBJ is inevitably probabilistic. Therefore, the adder 220 adds together the output signals Sout from the SPAD circuits 68, which can only detect incident light probabilistically.

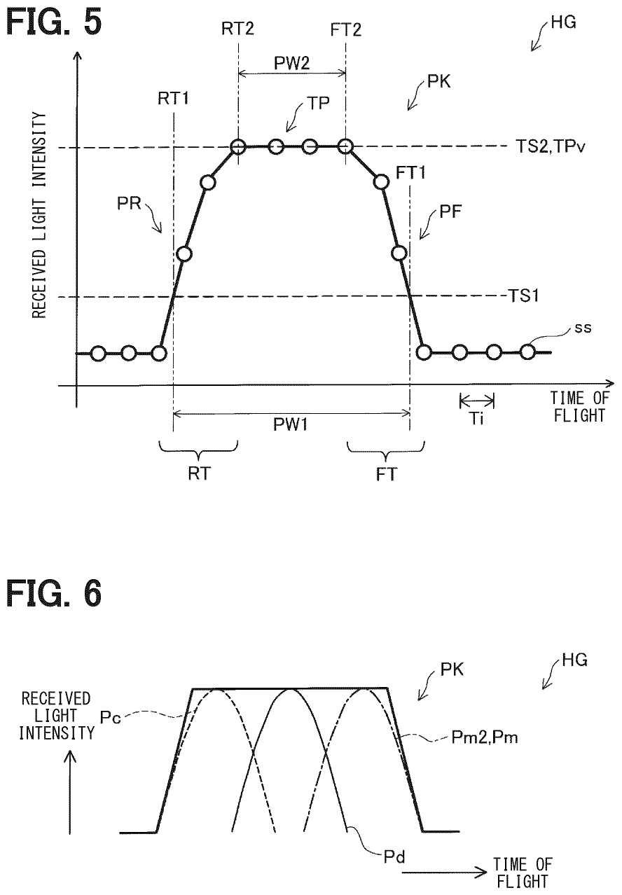

The histogram generation unit 230 generates a histogram HG, which expresses the received light intensity of the reflected light received by the light receiver 60 for each time of flight, based on the output signals Sout. More specifically, the histogram generation unit 230 acquires the addition result from the adder 220 and generates the histogram HG based on the time-series record of the addition results at predetermined time intervals Ti (for example, 1 nanosecond), and stores it in the storage unit 290. The received light intensity in the histogram HG is represented by the total number of SPAD circuits 68 that detected light within one pixel 66. In FIG. 5, the histogram HG is represented by a schematic graph with a horizontal axis indicating the time of flight and a vertical axis indicating the received light intensity. The histogram generation unit 230 generates such the histogram HG by linearly interpolating each received light intensity ss recorded at the time intervals Ti. By performing this linear interpolation, time resolution of the histogram HG becomes higher than the time resolution determined by the time interval Ti.

FIG. 5 shows an example of the histogram HG generated when the object is within the short-distance range, which will be described later. In the histogram HG shown in FIG. 5, a peak PK of received light intensity appears. The peak PK has a rising section PR, which rises toward an apex TP of the peak PK, and a falling section PF, which descends from the apex TP. The rising section PR can also be described as a portion of the peak PK in which the received light intensity increases toward the peak intensity TPv. The peak intensity TPv refers to the received light intensity at the apex TP of the peak PK. The falling section PF can also be described as a portion in which the received light intensity decreases from the peak intensity TPv. Hereinafter, a timing at which the rising section PR occurs is also referred to as a rising timing RT, and a timing at which the falling section PF occurs is also referred to as a falling timing FT. In the present embodiment, the rising timing RT and the falling timing FT are each represented by the flight time.

As shown in FIG. 5, the rising timing RT includes a first rising timing RT1 and a second rising timing RT2. The first rising timing RT1 is a timing, among the rising timing RT, at which the received light intensity reaches a first threshold TS1. The second rising timing RT2 is a timing, among the rising timing RT, at which the received light intensity reaches a second threshold TS2. The second threshold TS2 is greater than the first threshold TS1. Further, the falling timing FT includes a first falling timing FT1 and a second falling timing FT2. The first falling timing FT1 is a timing, among the falling timing FT, at which the received light intensity reaches the first threshold TS1. The second falling timing FT2 is the timing, among the falling timings FT, at which the received light intensity reaches the second threshold TS2. Details of the first threshold TS1 and the second threshold TS2 will be described later.

In FIG. 5, a first time width PW1 and a second time width PW2 are shown. The first time width PW1 represents a time between the first rising timing RT1 and the first falling timing FT1 in the histogram HG. The second time width PW2 represents a time between the second rising timing RT2 and the second falling timing FT2 in the histogram HG.

In FIG. 6, the peak PK of FIG. 5 is schematically shown. As shown in FIG. 6, the peak PK illustrated in FIG. 5 is a composite peak formed by the superposition of a clutter peak Pc, a desired signal peak Pd, and a multipath reflection peak Pm. The clutter peak Pc represents a peak based on the reflected light P3, that is, the peak caused by clutter. The desired signal peak Pd represents a peak based on the reflected light P2. More specifically, the desired signal peak Pd is a peak based on reflected light that has undergone a single reflection, and is a peak different from both the clutter peak Pc and the multipath reflection peak Pm. The multipath reflection peak Pm2 represents a peak based on the reflected light P4, that is, the peak caused by multipath reflection. More specifically, the multipath reflection peak Pm2 is a multipath reflection peak resulting from a second reflection. Hereinafter, peaks caused by multipath reflection will be simply referred to as multipath reflection peaks Pm, regardless of the number of reflections. It should be noted that, in FIG. 6, for convenience, an example is shown in which the clutter peak Pc and the desired signal peak Pd each have the same received light intensity. However, normally, the received light intensity of the clutter peak Pc is lower than that of the desired signal peak Pd. In addition, the received light intensity of the multipath reflection peak Pm may be comparable to that of the desired signal peak Pd, or it may be lower than that of the desired signal peak Pd.

The clutter peak Pc appears earlier in time than the desired signal peak Pd, while the multipath reflection peak Pm appears later in time than the desired signal peak Pd. When the number of reflections is three or more, peaks resulting from the third and subsequent reflections appear later in time than the multipath reflection peak Pm2 and may be superimposed on the multipath reflection peak Pm2. In this specification, the meaning of “the multipath reflection peak Pm is superimposed on the desired signal peak Pd” includes not only cases where the multipath reflection peak Pm is directly superimposed on the desired signal peak Pd, but also cases where another multipath reflection peak Pm is further superimposed on the multipath reflection peak Pm that is already superimposed on the desired signal peak Pd. In addition, when the number of reflections is one, the multipath reflection peak Pm does not appear.

The short-distance determination unit 240 shown in FIG. 4 determines whether the object is within a predetermined short-distance range based on the rising timing RT in the histogram HG. The short-distance range refers to a range that is closer to the distance measurement device 100 than a predetermined threshold. More specifically, the short-distance range is defined, based on experiments and simulations, as a range close enough that the clutter peak Pc is superimposed on the desired signal peak Pd in the histogram HG. In this specification, a range farther than the short-distance range is also referred to as a long-distance range.

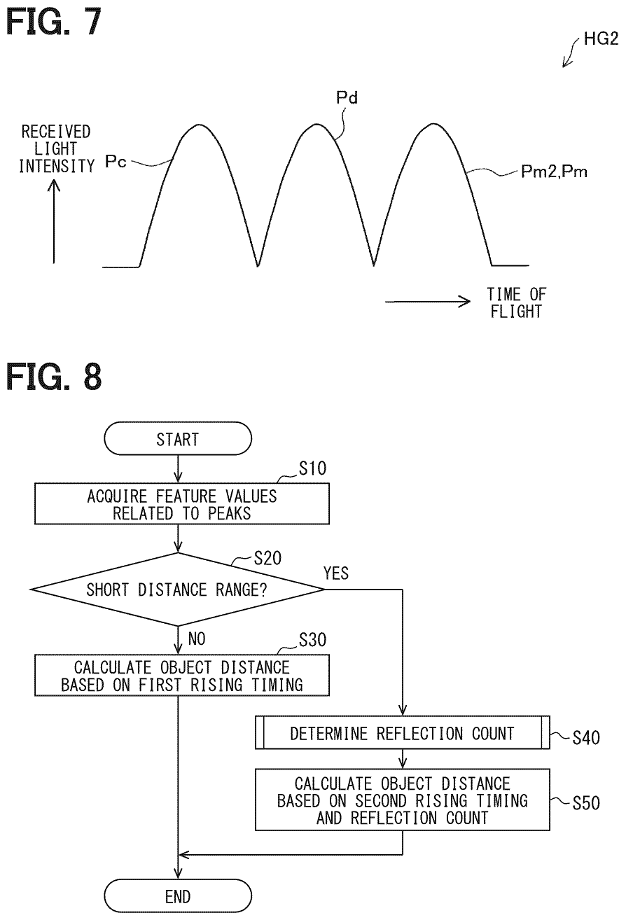

FIG. 7 schematically shows, as an example of a histogram, a histogram HG2 that is generated when the object is in the long-distance range. In the histogram HG2, unlike the histogram HG shown in FIGS. 5 and 6, the clutter peak Pc is not superimposed on the desired signal peak Pd. This is because, in the long-distance range, a distance between the object and the distance measurement device 100 is relatively large, so the reflected light from the object is received by the light receiver 60 after a relatively long time has elapsed since the clutter was received. Furthermore, when the distance between the object and the distance measurement device 100 is relatively large as described above, even if multiple reflections occur, the reflected light due to multiple reflections is received by the light receiver 60 after a relatively long time has elapsed since the reflected light from the object was received. As a result, in the long-distance range, not only the clutter peak Pc but also the multiple reflection peak Pm are not superimposed on the desired signal peak Pd. For example, in the histogram HG2 shown in FIG. 7, the multiple reflection peak Pm2 is not superimposed on the desired signal peak Pd.

The feature-value acquisition unit 250 shown in FIG. 4 acquires various feature values related to the peak PK based on the histogram HG generated by the histogram generation unit 230. These feature values include a reflection-count feature value, which is a feature value relating to the number of reflections. In the present embodiment, the feature-value acquisition unit 250 acquires, as reflection-count feature values, the first time width PW1 and the second time width PW2, which are feature values correlated with the number of reflections. When the object is within the short-distance range, the greater the number of reflections, the larger the first time width PW1 and the second time width PW2 tend to become. This is because, in the short-distance range, the greater the number of reflections, the larger the number of multiple reflection peaks Pm that are superimposed on the desired signal peak Pd.

As will be described later, when the object is within the short-distance range, the reflection-count determination unit 270 determines the number of reflections based on the reflection-count feature value.

The distance-calculation unit 260 calculates the object distance. When the object is within the short-distance range, the distance-calculation unit 260 calculates the object distance based on the reflection-count feature value and the falling timing FT. As will be described later, in the present embodiment, when the object is within the short-distance range, the distance-calculation unit 260 calculates the object distance based on the falling timing FT and the number of reflections determined from the reflection-count feature value. In addition, in the present embodiment, when the object is not within the short-distance range, the distance-calculation unit 260 calculates the object distance based on the rising timing RT.

The distance measurement process shown in FIG. 8 is executed to measure the object distance. The distance measurement process is started by the calculation unit 210, for example, at a timing when the histogram is generated by the histogram generation unit 230.

In step S10, the feature-value acquisition unit 250 identifies the peak PK in the generated histogram HG and acquires various feature values related to that peak PK. More specifically, in step S10, the feature-value acquisition unit 250 identifies the first rising timing RT1, the second rising timing RT2, the first falling timing FT1, and the second falling timing FT2, respectively, and acquires the time-of-flight values representing each of these timings. In addition, the feature-value acquisition unit 250 acquires the first time width PW1 and the second time width PW2 by calculating them based on the obtained values. For example, the feature-value acquisition unit 250 identifies two time-of-flight values at which the received light intensity at the peak PK reaches the first threshold TS1. Of the two identified time-of-flight values, the temporally earlier one is identified as the first rising timing RT1, and the temporally later one is identified as the first falling timing FT1. Similarly, the feature-value acquisition unit 250 identifies the second rising timing RT2 and the second falling timing FT2 based on two time-of-flight values at which the received light intensity at the peak PK reaches the second threshold TS2.

In step S20, the short-distance determination unit 240 determines whether the object is within the short-distance range. In step S20 of the present embodiment, the short-distance determination unit 240 determines whether the object is within the short-distance range based on the second rising timing RT2. In step S20, for example, the short-distance determination unit 240 determines that the object is within the short-distance range when a time corresponding to the second rising timing RT2 is equal to or less than a predetermined time threshold. In other embodiments, for example, the calculation unit 210 may calculate the distance based on the second rising timing RT2, and determine that the object is within the short-distance range if the calculated distance is equal to or less than a predetermined distance threshold.

It is preferable that the second threshold TS2 shown in FIG. 5 is set, for example, to a value that is not less than 80% and not more than 100% of the peak intensity TPv, and in the present embodiment, it is set to 100% of the peak intensity TPv. As described above, the received light intensity of the clutter peak Pc is generally smaller than that of the desired signal peak Pd. Therefore, by setting the second threshold TS2 to 80% or more of the peak intensity TPv, the influence of the clutter peak Pc on the second rising timing RT2 can be reduced.

If it is determined in step S20 that the object is not within the short-distance range, then in step S30, the distance-calculation unit 260 calculates the object distance based on the rising timing RT. More specifically, in step S30 of the present embodiment, the distance-calculation unit 260 calculates the object distance based on the first rising timing RT1. For example, the distance-calculation unit 260 calculates the object distance by using, as the time of flight of the pulsed light P1 and the reflected light P2, a value obtained by adding a time value Δt1 to a time indicated by the first rising timing RT1. The time value Δt1 is a value used to calculate a center position of the desired signal peak Pd based on the first rising timing RT1, and is predetermined, for example, based on a waveform of the pulsed light P1.

It is preferable that the first threshold TS1 shown in FIG. 5 is set, for example, to a value that is not less than 40% and not more than 70% of the peak intensity TPv. In the present embodiment, it is set to 50% of the peak intensity TPv. Among the rising timings RT, in a range where the received light intensity takes a value of not less than 40% and not more than 70% of the peak intensity TPv, the accuracy of linear interpolation is higher. Therefore, by setting the first threshold TS1 as described above, the object distance can be calculated with higher accuracy based on the first rising timing RT1. Normally, the accuracy of linear interpolation at the first rising timing RT1 is higher than the accuracy of linear interpolation at the second rising timing RT2. Therefore, by using the first rising timing RT1, the object distance can be calculated with higher accuracy compared to a case where the second rising timing RT2 is used. Similarly, normally, the accuracy of linear interpolation at the first falling timing FT1 is higher than the accuracy of linear interpolation at the second falling timing FT2.

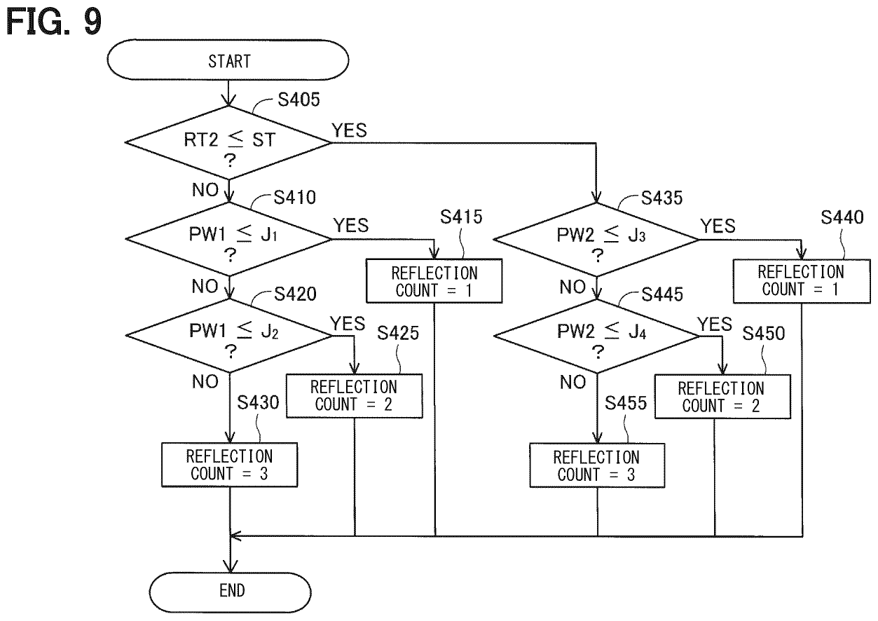

When it is determined in step S20 of FIG. 8 that the object is within the short-distance range, then in step S40, the reflection-count determination unit 270 determines the number of reflections. In step S40 of the present embodiment, the reflection-count determination unit 270 determines the number of reflections by executing the reflection-count determination process shown in FIG. 9.

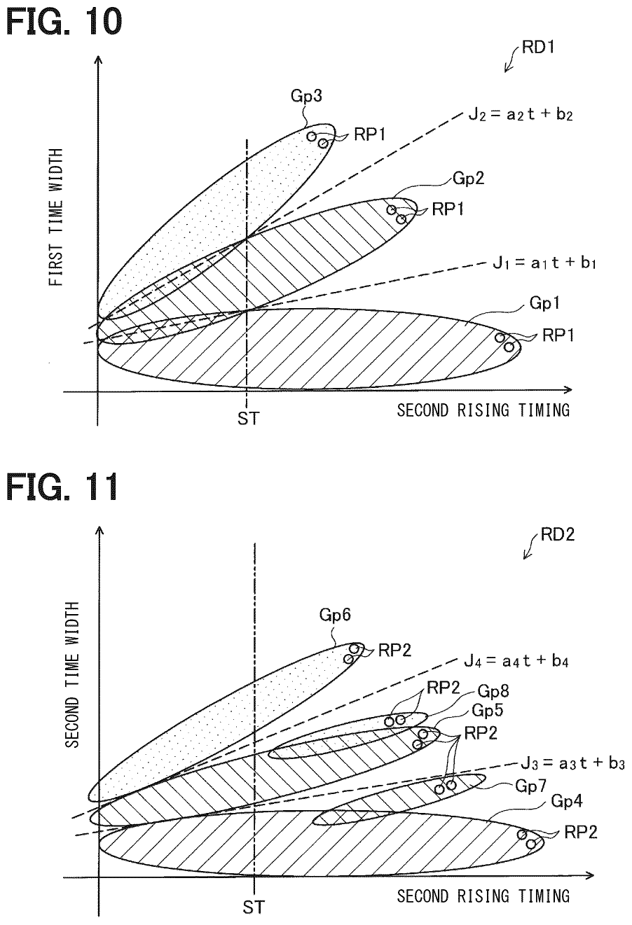

In step S405 of FIG. 9, the reflection-count determination unit 270 determines whether the second rising timing RT2, which was identified in step S10 of FIG. 8, occurs before a reference timing ST shown in FIG. 10 or FIG. 11. The reference timing ST is used to determine whether to use the first time width PW1 or the second time width PW2 as the reflection-count feature value when determining the number of reflections using the second rising timing RT2 and the reflection-count feature value. As will be described later, when the second rising timing RT2 is after the reference timing ST, the reflection-count determination unit 270 uses the first time width PW1 as the reflection-count feature value. On the other hand, when the second rising timing RT2 is before or at the reference timing ST, the reflection-count determination unit 270 uses the second rising timing RT2 as the reflection-count feature value.

When the second rising timing RT2 is after the reference timing ST, the reflection-count determination unit 270 determines the number of reflections, in steps S410 to S430 of FIG. 9, based on the correspondence between the second rising timing RT2 and the first time width PW1 as the reflection-count feature value. First, in step S410, the reflection-count determination unit 270 determines whether the first time width PW1 is less than or equal to the first judgment value J₁. In the present embodiment, the first judgment value J₁ is defined as a function of the second rising timing RT2, and is represented by the following equation (1).

$${J}_{1} = {a}_{1} t + {b}_{1} \qquad ( 1 )$$

A time t represents the second rising timing RT2. Coefficients a₁ and b₁ are determined based on the first relational data RD1 shown in FIG. 10. Details of the first relational data RD1 will be described later.

When the first time width PW1 is equal to or less than the first judgment value J₁, the reflection-count determination unit 270 determines, in step S415, that the number of reflections is one. On the other hand, when the first time width PW1 is greater than the first judgment value J₁, the reflection-count determination unit 270 determines, in step S420 of FIG. 8, whether the first time width PW1 is equal to or less than the second judgment value J₂. The second judgment value J₂ in the present embodiment is defined, similarly to the first judgment value J₁, as a function of the second rising timing RT2, and is represented by the following equation (2).

$${J}_{2} = {a}_{2} t + {b}_{2} \qquad ( 2 )$$

A coefficient a2 and coefficient b₂ are determined, in substantially the same manner as the above-mentioned coefficient a₁ and coefficient b₁, based on the first relational data RD1. When the first time width PW1 is equal to or less than the second judgment value J₂, the reflection-count determination unit 270 determines, in step S425, that the number of reflections is two. Further, when the first time width PW1 is greater than the second judgment value J₂, the reflection-count determination unit 270 determines, in step S430, that the number of reflections is three.

The first relational data RD1 shown in FIG. 10 is data representing a relationship between the second rising timing RT2 for each distance measurement and the first time width PW1 when the object is within the short-distance range. Hereinafter, a relationship between the second rising timing RT2 and the first time width PW1 will also be referred to as a first relationship RP1. The first relational data RD1 is data related to distance measurements that have been previously performed through experiments or simulations. For example, it is generated by associating and recording the second rising timing RT2 and the first time width PW1 for each distance measurement based on the results of experiments or simulations. In FIG. 10, the first relational data RD1 is represented in more detail by a graph with a horizontal axis indicating the second rising timing RT2 and a vertical axis indicating the first time width PW1, specifically as a scatter plot in which each first relationship RP1 is depicted as a data point. It should be noted that, in FIG. 10, only a portion of the data points representing the first relationship RP1 are shown as representative examples. The first relational data RD1 includes not only the first relationship RP1 in cases where multiple reflections do not occur, but also the first relationship RP1 in cases where multiple reflections do occur. For example, the first relational data RD1 shown in FIG. 10 includes the first relationship RP1 for cases in which the number of reflections is one, two, or three, respectively. In addition, the first relational data RD1 shown in FIG. 10 includes the first relationship RP1 in cases where superposition of the clutter peak Pc on the desired signal peak Pd has occurred. It should be noted that, in the first relational data RD1 according to the present embodiment, the number of reflections is associated with each first relationship RP1.

FIG. 10 shows a first group Gp1, a second group Gp2, and a third group Gp3, each including data points. In FIG. 10, the first group Gp1 is indicated by upward-slanting hatching, the second group Gp2 is indicated by downward-slanting hatching, and the third group Gp3 is indicated by dotted hatching. The first group Gp1, the second group Gp2, and the third group Gp3 respectively represent groups of the first relationship RP1 in cases where the number of reflections is one, two, and three. As shown in FIG. 10, the first group Gp1, the second group Gp2, and the third group Gp3 are distributed further apart from each other as the second rising timing RT2 increases. This is because, as the object distance increases, the multiple reflection peak Pm is superimposed on the desired signal peak Pd at a later timing, and an increment of the first time width PW1 due to an increase in the number of reflections becomes larger.

The coefficient a₁ and the coefficient b₁ of the aforementioned first judgment value J₁ are defined such that, within a range that is temporally later than the reference timing ST in the first relational data RD1, a straight line representing the first judgment value J₁ is positioned between the first group Gp1 and the second group Gp2. For example, the coefficient a₁ and the coefficient b₁ are defined such that, in the first relational data RD1, the straight line representing the first judgment value J₁ is positioned between the first group Gp1 and the second group Gp2, and is located farther from each data point included in the first group Gp1 and the second group Gp2. Further, the coefficient a2 and the coefficient b₂ of the second judgment value J₂ are defined such that, when the second rising timing RT2 is later than the reference timing ST, a straight line representing the second judgment value J₂ is positioned between the second group Gp2 and the third group Gp3 on the first relational data RD1. For example, the coefficient a2 and the coefficient b₂ are defined, in substantially the same manner as the coefficient a₁ and the coefficient b₁, such that a straight line representing the second judgment value J₂ is positioned between the second group Gp2 and the third group Gp3, and is located farther from each data point included in the second group Gp2 and the third group Gp3. The coefficient a2 determined in this way has a value greater than the coefficient a₁, and the coefficient b₂ has a value greater than the coefficient b₁.

When the second rising timing RT2 is at or before the reference timing ST, the reflection-count determination unit 270 determines the number of reflections based on the correspondence between the second rising timing RT2 and the second time width PW2, which serves as a reflection-count feature value, in steps S435 to S455 of FIG. 9. First, in step S435, the reflection-count determination unit 270 determines whether the second time width PW2 is less than or equal to the third judgment value J₃. In the present embodiment, the third judgment value J₃, like the first judgment value J₁ and the second judgment value J₂, is defined as a function of the second rising timing RT2 and is represented by the following equation (3).

$${J}_{3} = {a}_{3} t + {b}_{3} \qquad ( 3 )$$

A coefficient a₃ and a coefficient b₃ are determined based on the second relational data RD2 shown in FIG. 11. Details of the second relational data RD2 will be described later.

When the second time width PW2 is less than or equal to the third judgment value J₃, the reflection-count determination unit 270 determines, at step S440 in FIG. 9, that the number of reflections is one. When the second time width PW2 is greater than the third judgment value J₃, the reflection-count determination unit 270 determines at step S445 whether the second time width PW2 is less than or equal to the fourth judgment value J₄. The fourth judgment value J₄ in the present embodiment is defined, similarly to the first judgment value J₁ and the third judgment value J₃, as a function of the second rising timing RT2, and is represented by the following equation (4).

$${J}_{4} = {a}_{4} t + {b}_{4} \qquad ( 4 )$$

A coefficient a₄ and a coefficient b₄, like the coefficient a₃ and the coefficient b₃, are determined based on the second relational data RD2. When the second time width PW2 is less than or equal to the fourth judgment value J₄, the reflection-count determination unit 270 determines, at step S450, that the number of reflections is two. Further, when the second time width PW2 is greater than the fourth judgment value J₄, the reflection-count determination unit 270 determines, at step S455, that the number of reflections is three.

The second relational data RD2 shown in FIG. 11 is data representing a relationship between the second rising timing RT2 and the second time width PW2 for each distance measurement when the object is within the short-range area. Hereinafter, a relationship between the second rising timing RT2 and the second time width PW2 will also be referred to as a second relationship RP2. The second relational data RD2, like the first relational data RD1, is data relating to distance measurements previously carried out through experimental simulation. For example, similarly to the first relational data RD1, it is generated by recording the association between the second rising timing RT2 and the second time width PW2 for each distance measurement. In FIG. 11, the second relational data RD2 is represented, similarly to FIG. 10, by a scatter plot in which each second relationship RP2 is shown as a data point.

FIG. 11 shows a fourth group Gp4, a fifth group Gp5, and a sixth group Gp6, each including data points. In FIG. 11, the fourth group Gp4 is indicated by upward-right hatching, the fifth group Gp5 is indicated by downward-right hatching, and the sixth group Gp6 is indicated by dotted hatching. The fourth group Gp4, the fifth group Gp5, and the sixth group Gp6 respectively represent groups of the second relationship RP2 in cases where the number of reflections is one, two, and three. As shown in FIG. 11, the fourth group Gp4, the fifth group Gp5, and the sixth group Gp6 are distributed apart from each other as the second rising timing RT2 increases, similarly to the first group Gp1 to the third group Gp3 in FIG. 10.

Each coefficient of the above-described third judgment value J₃ is set such that, when the second rising timing RT2 is before the reference timing ST, a straight line representing the third judgment value J₃ on the second relational data RD2 is positioned between the fourth group Gp4 and the fifth group Gp5. Further, each coefficient of the fourth judgment value J₄ is set such that, when the second rising timing RT2 is before the reference timing ST, a straight line representing the fourth judgment value J₄ on the second relational data RD2 is positioned between the fifth group Gp5 and the sixth group Gp6. Each of these coefficients is determined in substantially the same manner as, for example, each coefficient of the first judgment value J₁ or each coefficient of the second judgment value J₂. The coefficient a₄ determined in this manner is greater than the coefficient a₃ and smaller than the coefficient a2. Further, the coefficient b₄ is greater than the coefficient b₃ and smaller than the coefficient b₂. Further, the coefficient as is smaller than the coefficient a₁, and the coefficient b₃ is smaller than the coefficient b₁.

It should be noted that, in other embodiments, the first judgment value J₁, the second judgment value J₂, the third judgment value J₃, and the fourth judgment value J₄ do not necessarily have to be defined as linear functions. For example, these judgment values may be defined as functions of second order or higher, exponential functions, or the like with respect to the second rising timing RT2.

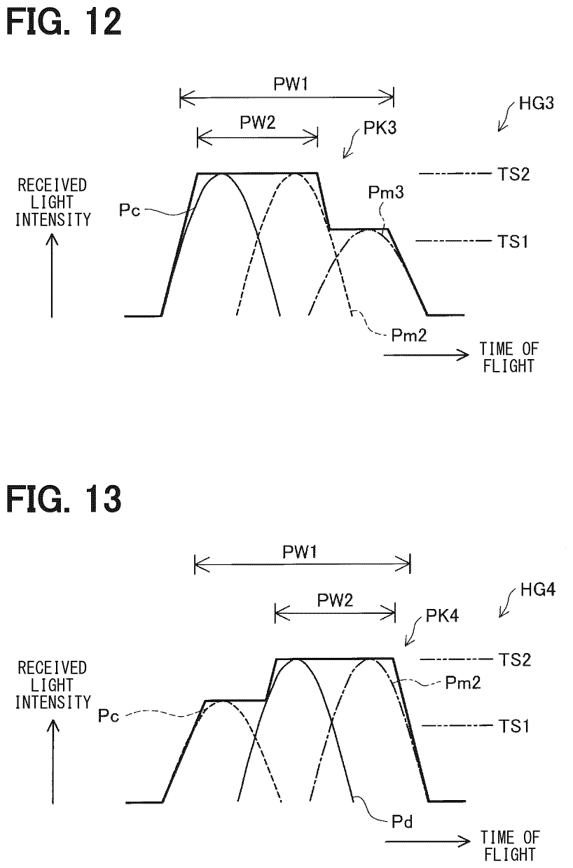

FIG. 12 shows, as an example of a histogram HG, a histogram HG3. In the histogram HG3, a composite peak PK3, in which a desired signal peak Pd, a multiple reflection peak Pm2, and a multiple reflection peak Pm3 that overlap each other are combined, is shown. The multiple reflection peak Pm3 is a multiple reflection peak resulting from a third reflection. In FIG. 12, the intensity of the multiple reflection peak Pm3 is higher than the first threshold TS1 and lower than the second threshold TS2.

In the example shown in FIG. 12, since the received light intensity of the multiple reflection peak Pm is lower than the second threshold TS2, the multiple reflection peak Pm is excluded from a range of the second time width PW2. Therefore, in this case, if the second time width PW2 is used as the reflection-count feature value, there is a high possibility that the number of reflections will be determined to be less than the actual number. For example, the seventh group Gp7 shown in FIG. 11 represents a group of the second relationship RP2 in a case where the number of reflections is two and the received light intensity of the multiple reflection peak Pm is lower than the second threshold TS2. In FIG. 11, the seventh group Gp7 is indicated by upward right hatching, similarly to the fifth group Gp5. In FIG. 11, the seventh group Gp7 overlaps with the fourth group Gp4. Therefore, when the received light intensity of the multiple reflection peak Pm is lower than the second threshold TS2, there is a possibility that, even if the actual number of reflections is two, the number of reflections may be determined as one based on the third judgment value J₃. In addition, the eighth group Gp8 represents a group of the second relationship RP2 in a case where the number of reflections is three and the received light intensity of the peak caused by the third reflection is lower than the second threshold TS2. In FIG. 11, the eighth group Gp8 is indicated by a dotted pattern hatching, similarly to the sixth group Gp6. In FIG. 11, the eighth group Gp8 overlaps with the fifth group Gp5. Therefore, when the received light intensity of the peak caused by the third reflection is lower than the second threshold TS2, there is a possibility that, even if the actual number of reflections is three, the number of reflections may be determined as two based on the third judgment value J₃ and the fourth judgment value J₄.

As shown in FIG. 11, the second relationship RP2 represented by the seventh group Gp7 and the eighth group Gp8 is more likely to occur when the second rising timing RT2 is temporally later. This is because the received light intensity of the peaks caused by multiple reflections tends to decrease as the object distance increases, due to attenuation of the pulsed light between the distance measurement device 100 and the object. Therefore, it is preferable that the above-mentioned reference timing ST is set to an earlier timing such that the determination of the number of reflections can be reduced as being less than the actual number. In other words, it is preferable that the reference timing ST is set as the timing at which the second time width PW2 is not selected as the reflection amount feature value, in cases where the use of the second time width PW2 is likely to result in the number of reflections being determined as fewer than the actual number.

FIG. 13 shows, as an example of the histogram HG, a histogram HG4. In the histogram HG4, a combined peak PK4 is shown, which is formed by the superposition of a clutter peak Pc, a desired signal peak Pd, and a multiple reflection peak Pm2. In FIG. 13, the intensity of the clutter peak Pc is higher than the first threshold TS1 and lower than the second threshold TS2.

In the example shown in FIG. 13, due to the fact that the received light intensity of the clutter peak Pc is higher than the first threshold TS1, the clutter peak Pc is included within a range of the first time width PW1. In this case, if the first time width PW1 is used as a reflection-count feature value, there is a possibility that the number of reflections will be determined to be greater than the actual number. In particular, when the object distance is short, the clutter peak Pc and the desired signal peak Pd become temporally closer to each other. As a result, since the received light intensity of the clutter peak Pc is higher than the first threshold TS1, there is a higher likelihood that the number of reflections will be determined to be greater than the actual number. Therefore, it is preferable that the reference timing ST described above is set to a temporally later timing, to an extent that suppresses the likelihood of the number of reflections being determined to be greater than the actual number when the first time width PW1 is used as a reflection-count feature value. In other words, it is preferable that the reference timing ST is set as a timing at which the first time width PW1 is not selected as a reflection quantity feature value when there is a high possibility that using the first time width PW1 would result in the number of reflections being determined to be greater than the actual number.

In step S50 of FIG. 8, the distance-calculation unit 260 calculates the object distance based on the number of reflections determined in step S40 and the second falling timing FT2. For example, the distance-calculation unit 260 calculates the object distance by using, as the flight time of the pulsed light P1 and the reflected light P2, a value obtained by subtracting a time value Δt2 from a value obtained by dividing a time indicated by the first falling timing FT1 by the number of reflections. The time value At2 is, for example, predetermined based on a waveform of the pulsed light P1, as a value for calculating a central position of the desired signal peak Pd based on the first falling timing FT1.

According to the distance measurement device 100 of the present embodiment described above, when the object is within the short-distance range, the distance-calculation unit 260 calculates the object distance based on the reflection-count feature value and the peak falling timing FT. According to such a configuration, when the object is within the short-distance range, the object distance is calculated based on the peak falling timing FT. Therefore, a decrease in distance measurement accuracy caused by the superposition of a clutter peak Pc on the desired signal peak Pd can be reduced. In addition, since the object distance is calculated based on the reflection-count feature value, a decrease in the distance measurement accuracy caused by the superposition of the multiple reflection peak Pm on the desired signal peak Pd can be reduced. Therefore, a decrease in the distance measurement accuracy caused by the superposition of the clutter peak Pc or the multiple reflection peak Pm can be reduced.

In addition, in the present embodiment, when the object is not within the short-distance range, the distance-calculation unit 260 calculates the object distance based on the rising timing RT. Therefore, when the object is not within the short-distance range, the object distance can be easily calculated based on the rising timing RT.

In addition, in the present embodiment, the short-distance determination unit 240 determines whether the object is within the short-distance range based on the second rising timing RT2, at which the received light intensity reaches the second threshold TS2 that is greater than the first threshold TS1. The distance-calculation unit 260 calculates the object distance based on the first rising timing RT1, at which the received light intensity reaches the first threshold TS1, when the object is not within the short-distance range. In this way, it is possible to determine whether the object distance is within the short-distance range based on the second rising timing RT2, which is less likely to be affected by the clutter peak Pc compared to the first rising timing RT1. In addition, when the object distance is not within the short-distance range, the object distance is calculated based on the first rising timing RT1. Therefore, for example, compared to calculating the object distance based on the second rising timing RT2, the object distance can be calculated with higher accuracy.

In addition, in the present embodiment, when the object is within the short-distance range, the reflection-count determination unit 270 determines the number of reflections based on the reflection-count feature value, and the distance-calculation unit 260 calculates the object distance based on the determined number of reflections and the falling timing FT. Therefore, it is possible to determine the number of reflections based on the reflection-count feature value, and to calculate the object distance based on the determined number of reflections.

In addition, in the present embodiment, when the second rising timing RT2 is later than the reference timing ST, the reflection-count determination unit 270 determines the number of reflections based on the correspondence between the second rising timing RT2 and the first time width PW1. When the second rising timing RT2 is at or before the reference timing ST, the reflection count is determined based on the correspondence between the second rising timing RT2 and the second time width PW2. Then, the distance-calculation unit 260 calculates the object distance based on the number of reflections and the first falling timing FT1. In this manner, it is possible to more appropriately determine the number of reflections by taking into account the influence of the received light intensity of the clutter peak Pc on the first time width PW1 and the influence of the received light intensity of the multiple reflection peak Pm on the second time width PW2. The number of reflections determined in this way can then be used to calculate the object distance. In addition, since the number of reflections is determined based on the first falling timing FT1, the object distance can be calculated with higher accuracy compared to a case where the number of reflections is determined based on the second falling timing FT2, for example. Therefore, the object distance can be calculated more appropriately.

### Second Embodiment

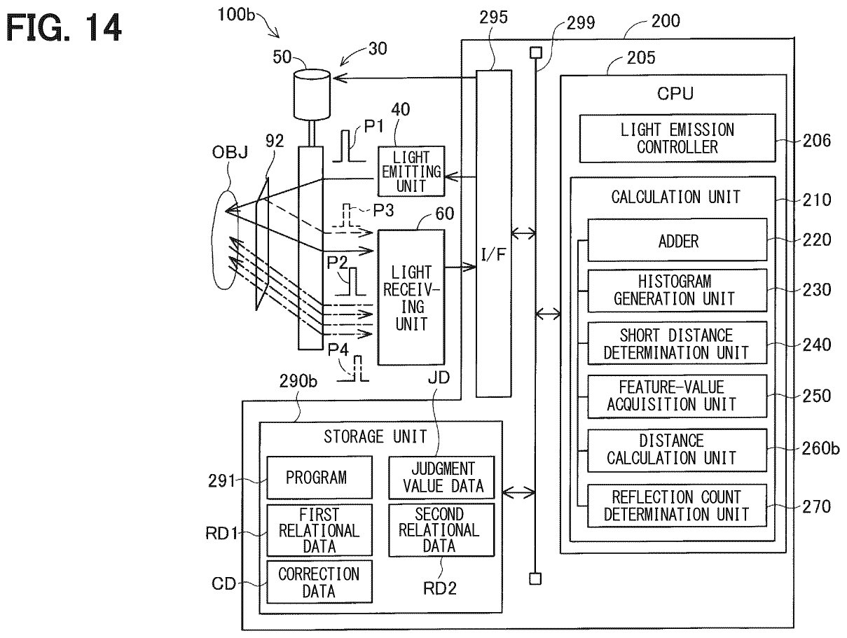

As shown in FIG. 14, a storage unit 290b of a distance measurement device 100b in a second embodiment, unlike in the first embodiment, stores correction data CD. In addition, the distance-calculation unit 260b in the present embodiment corrects the object distance based on the received light intensity in a histogram HG, as will be described later. The aspects of the configuration of the distance measurement device 100b in the second embodiment that are not specifically described are the same as those in the first embodiment.

The correction data CD is data for correcting the object distance based on the received light intensity. In the distance measurement device 100, even if the object distance is the same, a shape of the peak PK may change depending on the intensity of the reflected light. This is because the number of SPAD circuits 68 constituting the pixel 66 is finite, and the detection of reflected light by the SPAD circuits 68 constituting the pixel 66 is probabilistic. For example, when the intensity of the reflected light is relatively high (for instance, when the object has a high reflectivity), a large number of SPAD circuits 68 detect light even at the initial and final stages when the reflected light reaches the pixel 66. As a result, the rising timing RT occurs earlier, and the falling timing FT occurs later. On the other hand, when the intensity of the reflected light is relatively low, only a small number of SPAD circuits 68 detect light at the initial and final stages when the reflected light reaches the pixel 66. As a result, the rising timing RT becomes later, and the falling timing FT becomes earlier. The distance-calculation unit 260b in the present embodiment reduces the influence of changes in the rising timing RT and falling timing FT, which depend on the intensity of the reflected light as described above, by correcting the object distance using the correction data CD, thereby preventing such effects from impacting the calculated result of the object distance.

Furthermore, the inventors of the present application have found that trends of change due to the intensity of reflected light differ between the rising timing RT and the falling timing FT. More specifically, the inventors of the present application have found that a change amount in the falling timing FT due to the intensity of the reflected light is smaller than the change amount in the rising timing RT due to the intensity of the reflected light P2. In the present embodiment, the correction data CD is defined so as to enable correction of the object distance with different intensities depending on whether the rising timing RT or the falling timing FT is used in the calculation of the object distance, in accordance with the above-mentioned difference in trends.

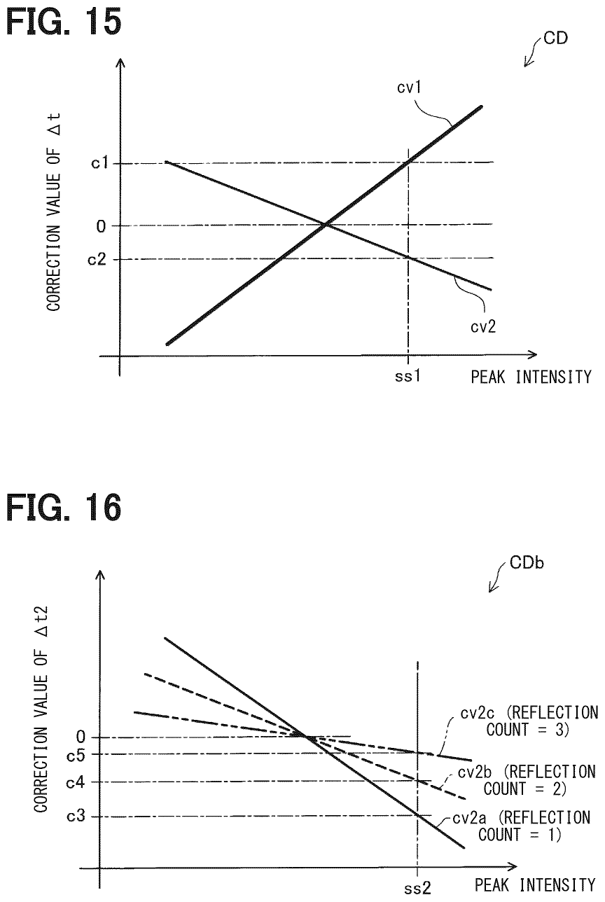

As shown in FIG. 15, the correction data CD in the present embodiment is data for correcting time values Δt1 and Δt2 based on the peak intensity TPv. As described in the first embodiment, the time value Δt1 is used to calculate the object distance based on the first rising timing RT1, and the time value Δt2 is used to calculate the object distance based on the first falling timing FT1. Hereinafter, when no distinction is made between the time value Δt1 and the time value Δt2, both are simply referred to as the time value Δt. The correction data CD shown in FIG. 15 includes a correction value cv1 for correcting the time value Δt1 and a correction value cv2 for correcting the time value Δt2. In the present embodiment, the correction value cv1 is defined as a positive linear function with respect to the peak intensity TPv. In addition, the correction value cv2 is defined as a negative linear function with respect to the peak intensity TPv. It should be noted that, in other embodiments, the correction values cv1 and cv2 may be defined, for example, as functions of the peak intensity TPv of second order or higher, exponential functions, or the like.

The correction value cv1 and the correction value cv2 are each defined such that the strength of correction differs from one another. For example, when the peak intensity TPv is the intensity ss1, the correction value cv1 is a value c1, and the correction value cv2 is a value c2. The absolute value of c1 is greater than the absolute value of c2. In the present embodiment, such a difference in the strength of correction is achieved by the absolute value of a slope of the correction value cv1 being greater than the absolute value of a slope of the correction value cv2.

In the present embodiment, at step S30 in FIG. 8, the distance-calculation unit 260b calculates the object distance using the time value Δt1, which has been corrected based on the correction value cv1 included in the correction data CD. Further, at step S50, the distance-calculation unit 260b calculates the object distance using the time value Δt2, which has been corrected based on the correction value cv2. By doing so, the object distance calculated by the distance-calculation unit 260b is corrected based on the received light intensity, and more specifically, based on the peak intensity TPv. Further, the object distance is corrected such that the strength of the correction differs depending on whether the rising timing RT or the falling timing FT is used in the calculation of the object distance.

According to the second embodiment described above, the distance-calculation unit 260b corrects the object distance based on the received light intensity. In this way, the object distance can be corrected based on the received light intensity. Therefore, the influence on the calculated result of the object distance caused by changes in the rising timing RT or falling timing FT depending on the intensity of the reflected light can be reduced. Accordingly, the object distance can be calculated with higher accuracy.

In the present embodiment, the distance-calculation unit 260b varies the degree of correction applied to the object distance depending on whether the rising timing RT or the falling timing FT is used for calculating the object distance. Therefore, regardless of whether the rising timing RT or the falling timing FT is used for calculating the object distance, the possibility of appropriately correcting the object distance is increased.

In the second embodiment, the distance-calculation unit 260b corrects the object distance by correcting the time values Δt1 and Δt2 based on the received light intensity. However, in other embodiments, the object distance may be corrected based on the received light intensity by methods different from those described above. For example, the object distance calculated by the distance-calculation unit 260b may be corrected based on the received light intensity. Additionally, the object distance may be corrected by correcting the first rising timing RT1 or the first falling timing FT1 based on the received light intensity. Further, the second rising timing RT2 and the second falling timing FT2 may be corrected based on the received light intensity, or the distance to the external object calculated using the second rising timing RT2 or the second falling timing FT2 may be corrected based on the received light intensity. Such correction may be used not only for calculating the object distance, but also, for example, for determining whether the object is within the short distance range in step S20, or for the various determinations in the steps shown in FIG. 9.

In addition, second correction data CDb in another embodiment shown in FIG. 16, unlike the correction data CD, includes, as correction values for the time value Δt2, a correction value cv2a for a case where the number of reflections is one, a correction value cv2b for a case where the number of reflections is two, and a correction value cv2c for a case where the number of reflections is three. The correction values cv2a, cv2b, and cv2c are each defined, like the correction value cv2 in FIG. 15, as negative functions with respect to the peak intensity TPv, but the slope of each correction value is different. More specifically, the absolute value of the slope of each correction value increases in the order of correction value cv2a, cv2b, and cv2c. It should be noted that, in FIG. 16, the correction values for the time value Δt1 are omitted. The distance-calculation unit 260b, in step S50 of FIG. 8, can vary the degree of correction applied to the object distance according to the determined number of reflections by using this correction data CDb. For example, when the received light intensity is the intensity ss2, the correction value cv2a takes a value c3, the correction value cv2b takes a value c4, and the correction value cv2c takes a value c5. The absolute values of these values increase in the order of c3, c4, and c5.

### Other Embodiments

In the above embodiment, the distance-calculation unit 260 calculates the object distance based on the first rising timing RT1 when the object is not within the short-distance range, but it is not necessary to calculate the object distance in this manner. For example, the distance-calculation unit 260 may calculate the object distance based on the second rising timing RT2. Further, the distance-calculation unit 260 may calculate the object distance based on the first falling timing FT1 or the second falling timing FT2, instead of the rising timing RT.

In the above embodiment, the distance-calculation unit 260 calculates the object distance based on the first falling timing FT1 when the object is not within the short-distance range, but, for example, it may calculate the object distance based on the second falling timing FT2. In this case, for example, regardless of whether the second rising timing RT2 is before or after the reference timing ST, the second rising timing RT2 may be used as the reflection-count feature value to determine the number of reflections. More specifically, for example, in the case shown in FIG. 12, as described above, if the number of reflections is determined based on the correspondence between the second rising timing RT2 and the second time width PW2, the number of reflections is determined to be two. However, in this case, the second falling timing FT2 corresponds to the falling timing of the multiple reflection peak Pm2. Therefore, in this case, by measuring the object distance based on the second falling timing FT2 and the number of reflections (two), a decrease in distance measurement accuracy that would otherwise occur can be reduced due to the number of reflections being determined as less than the actual number.

In the above embodiment, for example, the number of reflections may be determined using a pre-generated machine learning model. This machine learning model is generated, for example, by pre-training a relationship between various feature values, including reflection-count feature values, and the number of reflections, so that it can determine the number of reflections based on various feature quantities including the reflection-count feature values. As such a machine learning model, for example, a neural network, a decision tree, a support vector machine, or the like can be applied. In addition, various machine learning algorithms such as supervised learning, unsupervised learning, or reinforcement learning may be used for the machine learning.

In the above embodiment, the calculation unit 210 includes a reflection-count determination unit 270, but it is not necessary to have the reflection-count determination unit 270. For example, in the distance measurement process, when the object is within the short-distance range, the object distance may be calculated based on the falling timing FT and the reflection-count feature values without determining the number of reflections.

The control unit and the technique according to the present disclosure may be achieved by a dedicated computer provided by constituting a processor and a memory programmed to execute one or more functions embodied by a computer program. Alternatively, the controller described in the present disclosure and the method thereof may be implemented by a dedicated computer configured as a processor with one or more dedicated hardware logic circuits. Alternatively, the controller and method described in the present disclosure may be implemented using one or more dedicated computers, which include a combination of a processor consisting of one or more hardware logic circuits, and a processor and memory programmed to perform one or more functions. Additionally, the computer program may be stored on a computer-readable non-transitory tangible recording medium as instructions executed by a computer.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A distance measurement device comprising:
a light emitter configured to emit pulsed light;
a light receiver configured to receives reflected light of the pulsed light reflected by an object and output an output signal based on the reflected light; and
at least one of (i) a circuit and (ii) a processor with a memory storing computer program code executable by the processor, the at least one of the circuit and the processor configured to cause the distance measurement device to calculate an object distance to the object using a time of flight of the pulsed light, wherein
the at least one of the circuit and the processor is further configured to cause the distance measurement device to:
generate a histogram representing a received light intensity of the reflected light by the light receiver for each time of flight based on the output signal;
determine whether the object is within a predetermined short-distance range based on a rising timing of a peak of the received light intensity in the histogram;
acquire a feature value related to a number of reflections representing a number of times the pulsed light has reciprocated between the object and the light receiver by reflection based on the histogram; and
calculate the object distance based on the feature value and a falling timing of the peak when the object is within the short-distance range.

2. The distance measurement device according to claim 1, wherein
the at least one of the circuit and the processor is further configured to cause the distance measurement device to calculate the object distance based on the rising timing when the object is not within the short-distance range.

3. The distance measurement device according to claim 2, wherein
the rising timing includes a first rising timing at which the received light intensity indicates a first threshold and a second rising timing at which the received light intensity indicates a second threshold that is greater than the first threshold, and
the at least one of the circuit and the processor is further configured to cause the distance measurement device to:
determine whether the object is within the short-distance range based on the second rising timing; and
calculate the object distance based on the first rising timing when the object is not within the short-distance range.

4. The distance measurement device according to claim 3, wherein
the at least one of the circuit and the processor is further configured to cause the distance measurement device to:
determine the number of reflections based on the feature value, and
calculate the object distance based on the determined number of reflections and the falling timing when the object is within the short-distance range.

5. The distance measurement device according to claim 4, wherein
the falling timing includes a first falling timing at which the received light intensity indicates the first threshold and a second falling timing at which the received light intensity indicates the second threshold, and
the at least one of the circuit and the processor is further configured to cause the distance measurement device to determine the number of reflections, as the feature value, using either a first time representing a time period between the first rising timing and the first falling timing or a second time representing a time period between the second rising timing and the second falling timing as the feature value.

6. The distance measurement device according to claim 5, wherein
the at least one of the circuit and the processor is further configured to cause the distance measurement device to:
determine whether the second rising timing is before a predetermined reference timing when the object is within the short-distance range;
determine the number of reflections based on a correspondence relationship between the second rising timing and the first time when the second rising timing is after the reference timing;
determine the number of reflections based on a correspondence relationship between the second rising timing and the second time when the second rising timing is before the reference timing; and
calculate the object distance based on the determined number of reflections and the first falling timing.

7. The distance measurement device according to claim 1, wherein
the at least one of the circuit and the processor is further configured to cause the distance measurement device to correct the object distance based on the received light intensity.

8. The distance measurement device according to claim 7, wherein
the at least one of the circuit and the processor is further configured to cause the distance measurement device to vary an intensity of correction of the object distance between a case where the rising timing is used for calculating the object distance and a case where the falling timing is used for calculating the object distance.
